(19) United States
(12) Patent Application Publication
(10) Pub. No.: US 2006/0217963 A1
(43) Pub. Date: Sep. 28, 2006

(54) Translation memory system

(75) Inventors: Hiroshi Masuichi, Ashigarakami-gun (JP); Michihiro Tamune, Ashigarakami-gun (JP); Masatoshi Tagawa, Ebina-shi (JP); Kiyoshi Tashiro, Kawasaki-shi (JP); Atsushi Itoh, Ashigarakami-gun (JP); Kyosuke Ishikawa, Minato-ku (JP); Naoko Sato, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Toyko (JP)

(21) Appl. No.: 11/219,660

(22) Filed: Sep. 7, 2005

(30) Foreign Application Priority Data
Mar. 23, 2005 (JP) 2005-084903

(51) Int. Cl. G06F 17/28

(52) U.S. Cl. 704/7

(57) ABSTRACT

The present invention provides a translation memory system including: a memory which stores plural pairs of a natural language sentence written in a first language and an interlingua representation of the natural language sentence; an analysis unit which performs a syntactic and semantic analysis on a natural language sentence written in a second language and translates the natural language sentence into an interlingua representation on the basis of the analysis result; a search unit which searches the memory to identify an interlingua representation which corresponds to or has a predetermined level of similarity to the interlingua representation obtained by the analysis unit, and which extracts a natural language sentence written in the first language paired with the identified interlingua representation; and an output unit which outputs the natural language sentence extracted by the search unit as a translation result.

This application claims priority under 35 U.S.C. §119 of Japanese Patent Application No. 2005-84903 filed on Mar. 23, 2005, the entire content of which is hereby incorporated by reference.

### BACKGROUND OF THE INVENTION

2. Field of the Invention

The present invention relates to a translation memory system for translating one language to another.

2. Description of the Related Art

A language used by people for everyday communication such as Japanese or English is referred to as a “natural language”. A natural language is formed spontaneously, and a variety of languages have evolved. A natural language has many abstract and ambiguous properties, but can be processed by a computer in a number of ways when treated mathematically. In fact, through computer processing, applications and services relating to a natural language such as machine translation, a dialogue system, and a search system have been realized. Among such applications and services, machine translation supports communication between different languages through computer processing.

Among machine translation systems currently in practical use, there are two systems: a “direct system” and a “transfer system”. The direct system is a system in which words of a language to be translated (hereinafter, referred to as a “source language”) are simply replaced with corresponding words of a language into which the source language is translated (hereinafter, referred to as a “target language”) on the basis of a prepared word dictionary. The system is useful only in a case where the grammar of a source language is similar to that of a target language; for example, when translating between Japanese and Korean. In contrast, a transfer system, which includes a process of replacing syntactic structures in addition to a process of simply replacing words, is useful in a case that languages differ in grammar.

In addition to the above systems, there is a machine translation support system referred to as a “translation memory system (or a bilingual database system)”. In the translation memory system, a pair of a natural language sentence written in a source language (hereinafter, referred to as a “source language sentence”) and a natural language sentence written in a target language (hereinafter, referred to as a “target language sentence”), having the same meaning as the source language sentence, is stored in a storage; as many of such sentences as possible being stored in advance. When a natural language sentence to be translated is input, the storage is searched to identify a source language sentence which completely corresponds to or is similar to the input sentence, and a target language sentence which is paired with the source language sentence is output.

However, the translation memory system has a problem that it takes much time and effort to prepare a set of bilingual pairs. Therefore, when a new source language or a new target language is added; for example, where French is added to a translation memory system supporting translation between English and Japanese, enormous costs are incurred.

The present invention has been made with a view to addressing the problem discussed above, and provides a translation memory system which makes it possible to save time and effort for preparing a set of bilingual pairs between a newly added source language and existing target languages.

### SUMMARY OF THE INVENTION

To address the problem discussed above, the present invention provides a translation memory system including: a memory which stores plural pairs of a natural language sentence written in a first language and an interlingua representation of the natural language sentence; an analysis unit which performs a syntactic and semantic analysis on a natural language sentence written in a second language and translates the natural language sentence into an interlingua representation on the basis of the analysis result; a search unit which searches the memory to identify an interlingua representation which corresponds to or has a predetermined level of similarity to the interlingua representation obtained by the analysis unit, and which extracts a natural language sentence written in the first language paired with the identified interlingua representation; and an output unit which outputs the natural language sentence extracted by the search unit as a translation result.

According to the translation memory system, if a natural language sentence written in a source language which is not supported by the system is input, a syntactic and semantic analysis unit performs a syntactic and semantic analysis on the natural language sentence and translates the natural language sentence into an interlingua representation on the basis of the analysis result; a search unit identifies an interlingua representation which corresponds to or has a predetermined level of similarity to the interlingua representation, and extracts a natural language sentence written in a target language paired with the identified interlingua representation; and an output unit outputs the extracted natural language sentence as a translation result.

### BRIEF DESCRIPTION OF THE DRAWINGS

Embodiments of the present invention will be described in detail with reference to the following figures, wherein:

FIG. 1 is a diagram illustrating an example of an f-structure;

FIG. 2 is a diagram illustrating an example of a case structure;

FIG. 3 is a block diagram illustrating a configuration of a translation memory system according to a first embodiment of the present invention;

FIG. 4 is a conceptual diagram illustrating a relationship between a source language and target languages in a conventional translation memory system;

FIG. 5 is a conceptual diagram illustrating a relationship between a source language and target languages in a translation memory system according to the first embodiment;

FIG. 6 is a conceptual diagram illustrating an operation of translating a bilingual pair of natural language sentences into bilingual pairs of an interlingua representation and a natural language sentence;

FIG. 7 is a block diagram illustrating a configuration of a translation memory system according to a second embodiment of the present invention;

FIG. 8 is a diagram illustrating an example of translation from a bilingual pair of natural language sentences into bilingual pairs of an interlingua representation and a natural language sentence;

FIG. 9 is a diagram illustrating an example of translation from a bilingual pair of natural language sentences into bilingual pairs of an interlingua representation and a natural language sentence;

FIG. 10 is a conceptual diagram illustrating ambiguity caused when a bilingual pair of natural language sentences is translated into bilingual pairs of an interlingua representation and a natural language sentence;

FIG. 11 is a diagram illustrating an example of a most superordinate structure of a case structure; and

FIG. 12 is a block diagram illustrating a configuration of a translation memory system according to a fourth embodiment of the present invention.

### DETAILED DESCRIPTION OF THE INVENTION

Embodiments of the present invention will be described with reference to the drawings.

### 1. First Embodiment

A translation memory system according to the present embodiment, instead of pre-storing bilingual pairs of natural language sentences as in the case of the related art, pre-stores bilingual pairs of an interlingua representation which is a representation by a non-language-specific interlingua and a natural language sentence, and makes a translation with reference to the bilingual pairs. The term “interlingua” refers to a meta-language (descriptive language) common to plural natural languages, and is designed to be interpreted by a computer. Such an interlingua has been proposed for use in several methods so far, and among the methods, there is an f-structure which is gained by an analysis based on a language analytic theory referred to as LFG (Lexical Functional Grammar). LFG is expounded in a publication: Miriam Butt, et al., “A Grammar Writer's Cookbook”, CSLI Publication (1999). The f-structure is characterized in that syntactic and semantic information of a sentence is represented in an embedded structure of pairs of an attribute and an attribute value. In the f-structure, word information constituting a sentence is described as an attribute value corresponding to an attribute referred to as PRED (predicate). In the f-structure, only the attribute value (word) corresponding to the PRED changes depending on languages and other attributes and attribute values are common to all languages. In other words, sentences sharing the same meaning are translated into identical f-structures except for their word information, even if languages of the sentences are different. Accordingly, if a source language sentence is translated into an interlingua representation, and a target language sentence having the same meaning as the interlingua representation can be identified, a correct translation result (target language sentence) can be obtained.

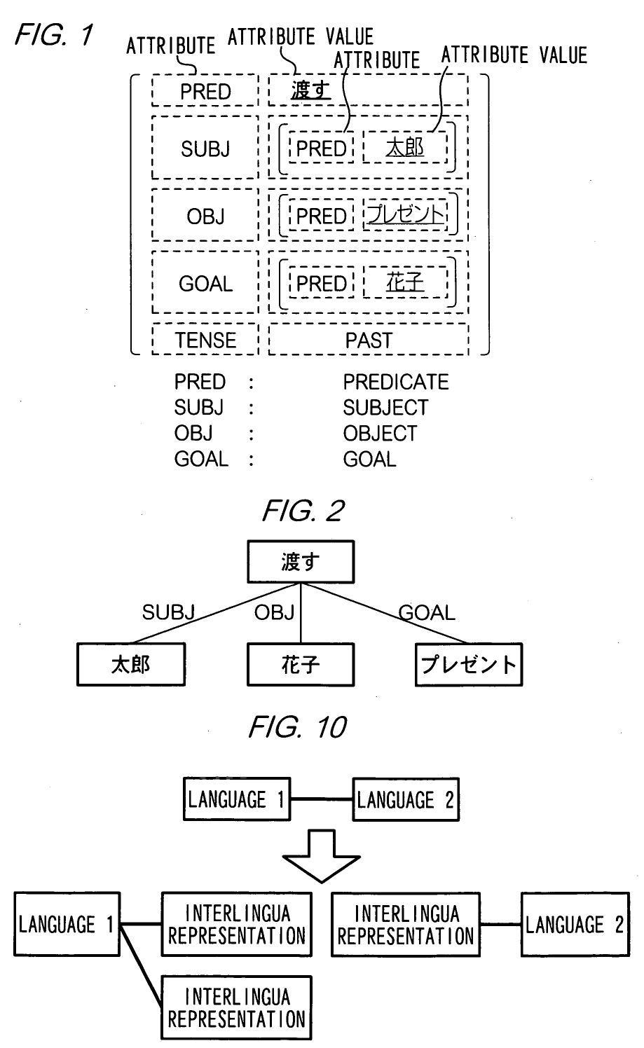

FIG. 1 is a diagram illustrating an example of an f-structure obtained as a result of an LFG analysis of a Japanese sentence [symbol] [symbol] [symbol] (a Japanese sentence meaning that Taro gave a present to Hanako.)”. In the drawing, an attribute and an attribute value corresponding to the attribute are arranged at an identical level. For example, an attribute “PRED” corresponds to an attribute value [symbol] (a Japanese word meaning “give”)”. Also, in the drawing, underlined elements are word information (an attribute value corresponding to an attribute “PRED”). Other elements are common to all languages and described in English. Attributes “PRED”, “SUBJ”, “OBJ”, and “GOAL” in the drawing mean predicate, subject, object, and second object, respectively.

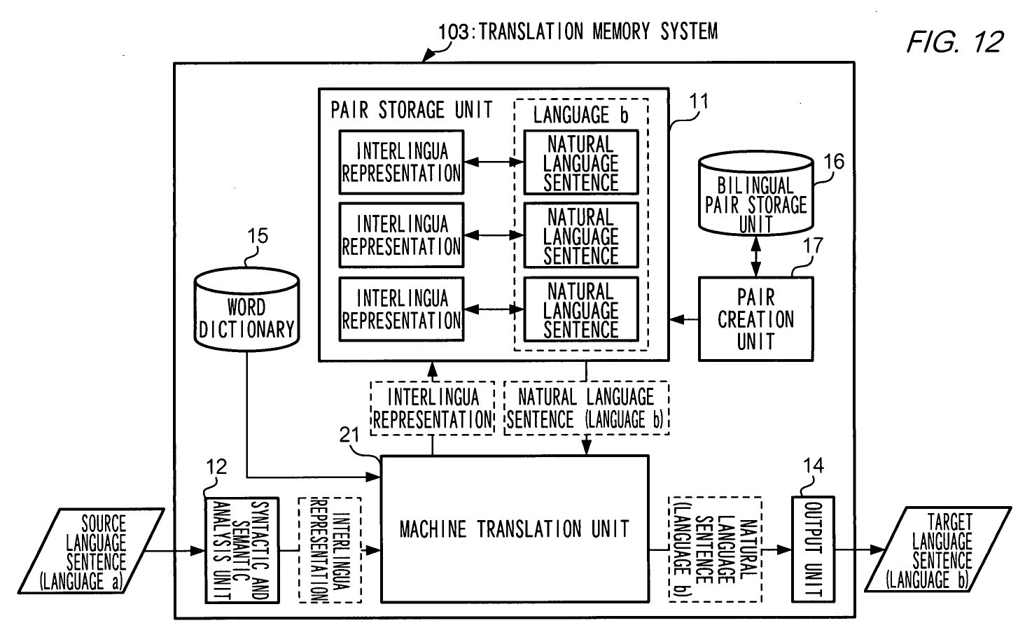

Other than the f-structure, as an interlingua, there is an MRS (Minimal Recursion Semantics) structure which is gained by a language analysis based on a language analytic theory referred to as HPSG (Head-driven Phrase Structure Grammar). The HPSG is expounded in the following publication: Ivan A. Sag, and Thomas Wasow, translated by Takao Gunji, and Yasunari Harada, “Introduction to Syntax”, Iwanami Shoten (2001), in Japanese, contents of which are hereby incorporated by reference. Also, a case structure representation (see the following publication: edited by Makoto Nagao, “Natural Language Processing”, Iwanami Shoten (1996), in Japanese, contents of which are hereby incorporated by reference) obtained by a common syntactic and semantic analysis may be used as an interlingua. For example, FIG. 12 illustrates a case structure representation of the Japanese sentence [symbol] [symbol] (a Japanese sentence meaning that Taro gave a present to Hanako.)” shown in FIG. 1. As shown in the drawing, a case structure representation is represented by a tree structure in which plural pieces of word information (node) constituting a sentence are associated hierarchically.

Either of the structures described above can be said to be, in essence, a representation of “dependency relations of words constituting a sentence” and “types of dependency (subject, object, etc.)”. For example, a publication: Hiroshi Masuichi, Tomoko Ohkuma, Hiroko Yoshimura, and Yasunari Harada, “Japanese parser on the basis of the Lexical-Functional Grammar Formalism and its Evaluation, In Proceedings of The 17^{th} Pacific Asia Conference on Language, Information and Computation (PACLIC17), pp. 298-309 (2003)”, in Japanese, contents of which are hereby incorporated by reference, expounds a method of translating (downgrading) an f-structure into a case structure representation, which means that an f-structure is a structure inclusive of a case structure representation.

Now, a translation memory system according to the present embodiment will be described. In the translation memory system, a case structure representation described above is used as an interlingua representation.

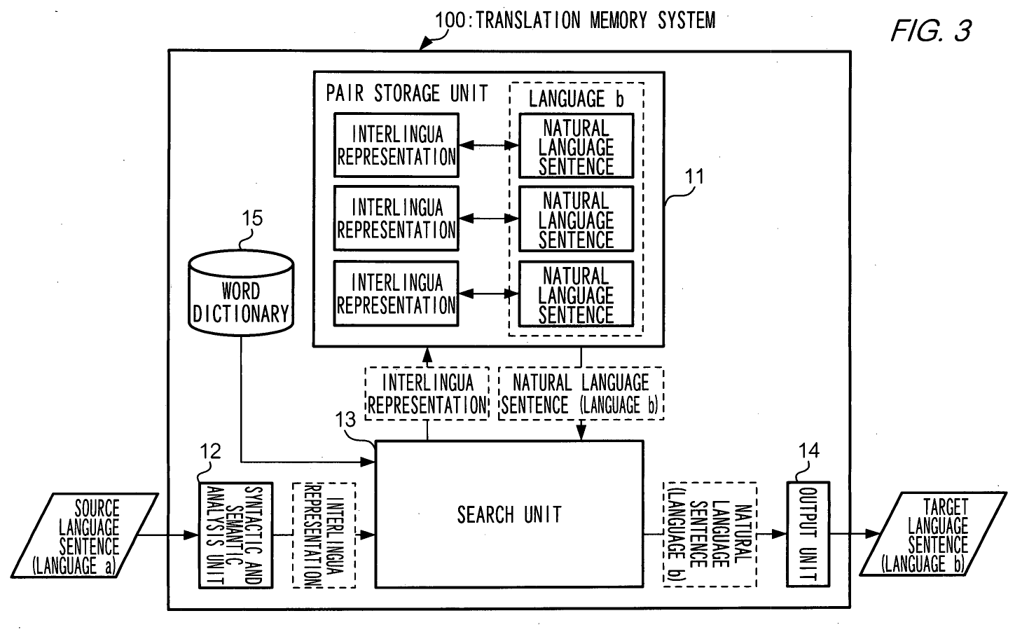

FIG. 3 is a block diagram illustrating a configuration of translation memory system 100 according to the present embodiment. Translation memory system 100 consists of a computer, and when the computer executes a program, pair storage unit 11, syntactic and semantic analysis unit 12, search unit 13, output unit 14, and word dictionary 15 shown in FIG. 3 are realized. Pair storage unit 11 is realized by a large capacity storage such as a hard disk, and stores plural pairs of a natural language sentence written in a target language and an interlingua representation of the natural language sentence. In FIG. 3, plural pairs of a natural language sentence written in a target language (language b) and an interlingua representation of the natural language sentence are stored.

Syntactic and semantic analysis unit 12, when a natural language sentence written in a source language (shown as language a) is input, performs a syntactic and semantic analysis on the natural language sentence and translates the natural language sentence into an interlingua representation. Search unit 13 searches pair storage unit 11 and thereby identifies an interlingua representation which corresponds to, or has a certain level of similarity to, the interlingua representation obtained via syntactic and semantic analysis 12. Search unit 13 also extracts a natural language sentence written in a target language (shown as language b) paired with the identified interlingua representation from pair storage unit 11. Output unit 14 outputs the natural language sentence extracted by search unit 13 as a translation result. An output method of output unit 14 may be displaying a translation result on a display and printing a translation result on a medium. Word dictionary 15 stores bilingual pairs of words, and is used when search unit 13 identifies an interlingua representation which corresponds to or has a certain level of similarity to an interlingua representation obtained via syntactic and semantic analysis 12.

A case structure representation which is used as an interlingua representation in the present embodiment is represented by a tree structure consisting of nodes of word information as shown in FIG. 2. Accordingly, pair storage unit 11 of translation memory system 100 shown in FIG. 3 stores a collection of pairs of a tree structure (interlingua representation), and a natural language sentence written in a target language. When a source language sentence is input into translation memory system 100, syntactic and semantic analysis unit 12 performs a syntactic and semantic analysis on the source language sentence and translates the source language sentence into a tree structure (interlingua representation). Search unit 13 identifies a tree structure which corresponds to or has a certain level of similarity to the tree structure obtained via syntactic and semantic analysis unit 12 from among tree structures stored in pair storage unit 11. Search unit 13 also extracts a natural language sentence paired with the tree structure identified by search unit 13 from pair storage unit 11. Output unit 14 outputs the natural language sentence extracted by search unit 13 as a target language sentence. It is to be noted that estimation of similarity of tree structures may be made using a commonly used method (see the following publication: Tetsuro Takahashi, Kentaro Inui, and Yuji Matsumoto, “Methods for Estimating Syntactic Similarity”, Information Processing Society of Japan Research Report, 2002-NL-150, pp. 163-170 (2002), in Japanese, contents of which are hereby incorporated by reference).

Next, an effect achieved by translation memory system 100 will be described specifically through a comparison with a related art.

First, a translation task performed using a related translation memory system will be described.

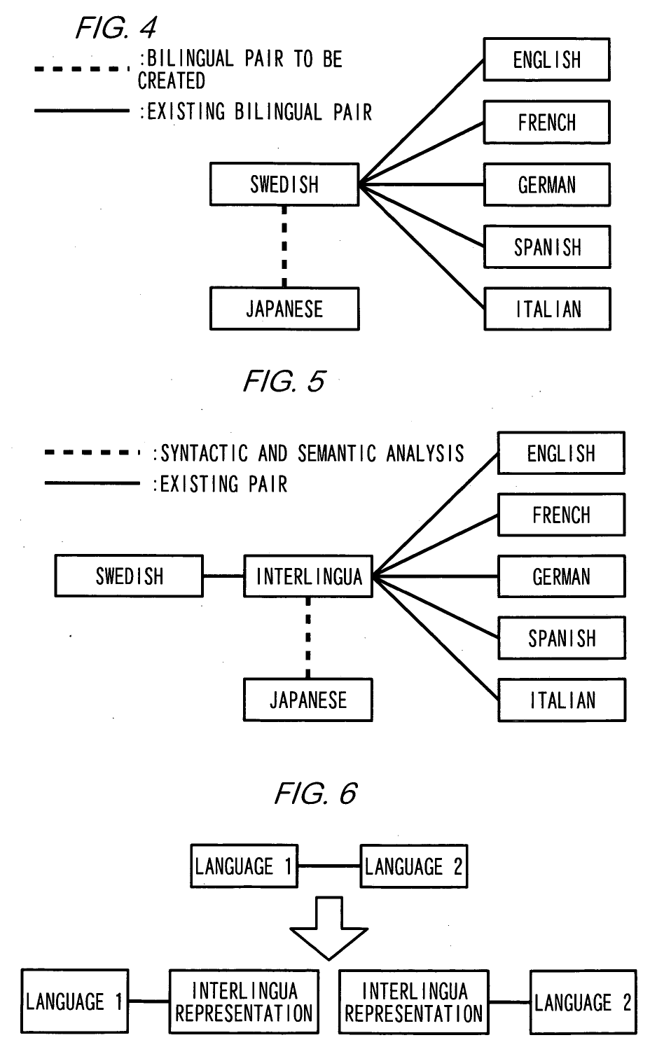

It is assumed that a translation company has received a request from a Swedish cellular phone manufacturer A to translate a user manual written in Swedish into English, French, German, Spanish, and Italian. When a translation using a related art translation memory system is requested, the translation memory system is expected to contain bilingual pairs of sentences, each written in two natural languages: “Swedish-English”, “Swedish-French”, “Swedish-German”, “Swedish-Spanish”, and “Swedish-Italian”, which have been created manually for the translation. FIG. 4 shows the bilingual pairs stored in the translation memory system conceptually.

Additionally, it is assumed that the translation company has received a new request from a Japanese cellular phone manufacturer B to translate a user manual written in Japanese into English, French, German, Spanish, and Italian. When the translation is made with the related art translation memory system, the translation company has to create at least bilingual pairs of sentences written in natural languages “Swedish-Japanese” to perform the translation, because the translation memory system does not contain bilingual pairs of sentences written in Japanese together with any of the above languages. Additionally, in some cases, the translation company might have to create bilingual pairs of sentences written in natural languages: “Japanese-English”, “Japanese-French”, “Japanese-German”, “Japanese-Spanish”, and “Japanese-Italian”.

Next, a case of a translation work using translation memory system 100 according to the present embodiment will be described.

First, given that the translation company using translation memory system 100 has received the above first translation request from the Swedish cellular phone manufacturer A and completed the translation, translation memory system 100 of the translation company is expected to have in pair storage unit 11, pairs of an interlingua representation together with each of Swedish, English, French, German, Spanish, and Italian sentences. FIG. 5 shows the pairs stored in pair storage unit 11 of translation memory system 100 conceptually.

Next, given that the translation company has received the above second translation request from Japanese cellular phone manufacturer B, and translates a user manual written in Japanese, first, syntactic and semantic analysis unit 12 of translation memory system 100 translates a natural language sentence written in Japanese into a case structure representation. Second, search unit 13 identifies in pair storage unit 11 a case structure representation which corresponds to or is similar to the case structure representation obtained via syntactic and semantic analysis unit 12, with reference to word dictionary 15 for translation between Japanese and each of English, Swedish, French, German, Spanish, and Italian. It is to be noted that when syntactic and semantic analysis unit 12 translates a source language sentence into a case structure representation, the source language sentence can be often translated into plural case structure representations which are different from each other, because of ambiguity of the source language sentence. In this case, search unit 13 identifies, for each of the case structure representations, a most similar case structure representation in pair storage unit 11, compares similarities of the pairs of case structure representations, and selects a case structure representation of a pair which marks the highest level similarity. This is because a case structure representation stored in pair storage unit 11 is a case structure representation of a correct natural language sentence, and therefore a case structure representation similar to the case structure representation stored in pair storage unit 11 is likely to be correct.

When a case structure representation is identified in pair storage unit 11, search unit 13 extracts natural language sentences written in target languages (English, Swedish, French, German, Spanish, and Italian) paired with the case structure representation from pair storage unit 11. Output unit 14 outputs the natural language sentences extracted by search unit 13 as a translation result.

As described above, according to the present embodiment, a source language sentence is translated into an interlingua representation, and existing pairs of an interlingua representation and a natural language sentence are used for translation of the source language sentence into a target language sentence. Accordingly, it is not necessary to create new bilingual pairs of the source language sentence and the target language sentence. Also, since the thus obtained target language sentence is a correct sentence as expressed by a native speaker, the target language sentence requires little subsequent correction by a human.

### 2. Second Embodiment

Pairs of an interlingua representation and a natural language sentence stored in pair storage unit 11 may be created manually, but the work takes much time and effort. However, according to the present embodiment described below, in a case where bilingual pairs of natural language sentences written in different languages have already been created, the bilingual pairs can be translated into pairs of an interlingua representation and a natural language sentence. Specifically, as shown in FIG. 6, a natural language sentence of a bilingual pair written in language 1 is subject to a syntactic and semantic analysis, and an interlingua representation of the natural language sentence is created on the basis of the analysis result, whereas a natural language sentence of the bilingual pair written in language 2 is subject to a syntactic and semantic analysis, and an interlingua representation of the natural language sentence is created on the basis of the analysis result. Then, the natural language sentence written in language 1 and the natural language sentence written in language 2 are associated with each other by an interlingua representation common to them.

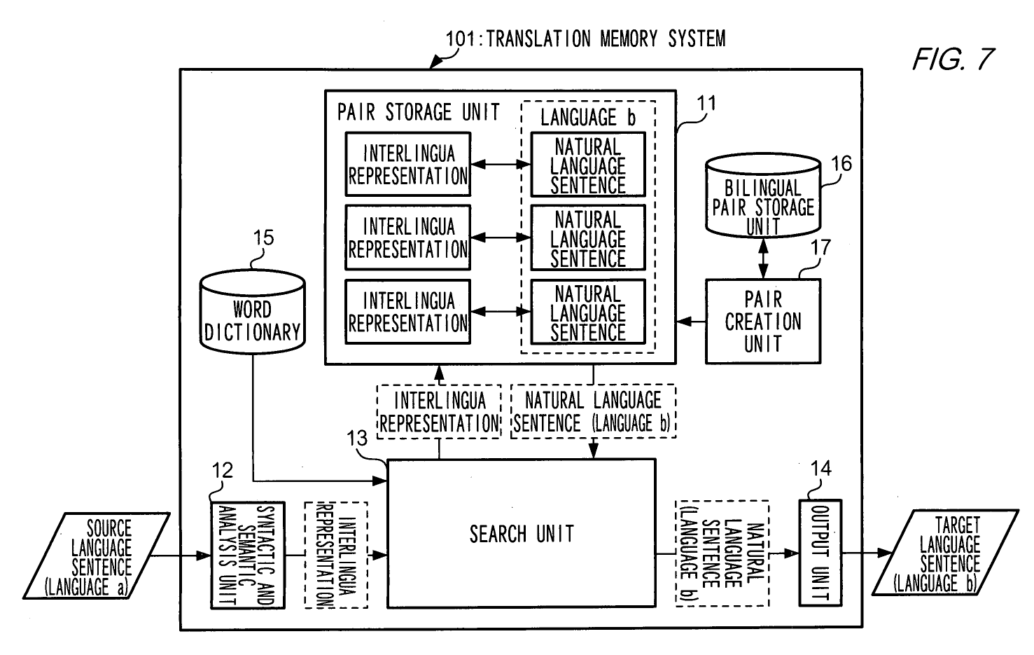

FIG. 7 is a block diagram illustrating a configuration of translation memory system 100 according to the present embodiment. As shown in the drawing, in translation memory system 101, in addition to pair storage 11, syntactic and semantic analysis unit 12, search unit 13, output unit 14, and word dictionary 15 which are realized in translation memory system 100 according to the first embodiment, bilingual pair storage unit 16 and pair creation unit 17 are realized. Bilingual pair storage unit 16 is realized by a large capacity storage such as a hard disk, and stores plural bilingual pairs of natural language sentences written in different languages. Pair creation unit 17 translates a bilingual pair stored in bilingual pair storage unit 16 into a pair of an interlingua representation and a natural language sentence, and stores it in pair storage unit 11.

Next, an operation of translation memory system 101 will be described with concrete descriptions.

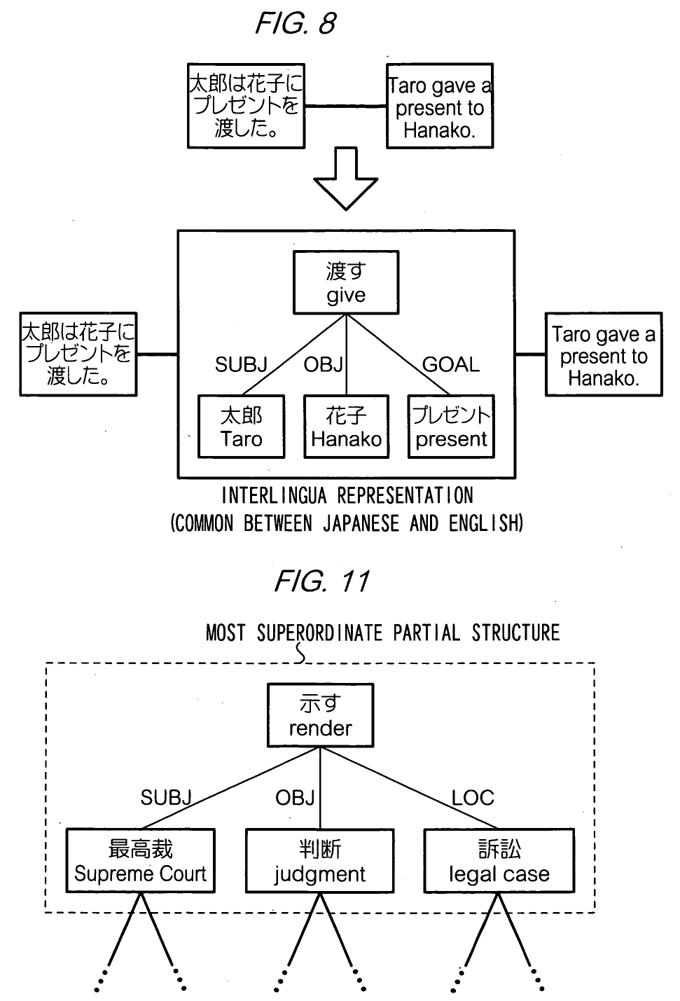

Given that a bilingual pair of a Japanese sentence [symbol] (a Japanese sentence meaning that Taro gave a present to Hanako)” and an English sentence “Taro gave a present to Hanako.” has been stored in pair storage unit 16, pair creation unit 17 performs a syntactic and semantic analysis on both the sentences, and describes, in an interlingua representation obtained on the basis of the analysis result, words of the sentences as word information, as shown in FIG. 8. Specifically, a Japanese term [symbol] (a Japanese term meaning “give”)” and an English term “give” are described, a Japanese term [symbol] (a Japanese term meaning “Taro”)” and an English term “Taro” are described as a subject, a Japanese term [symbol] (a Japanese term meaning “Hanako”)” and an English term “Hanako” are described as an object, and a Japanese term [symbol] (a Japanese term meaning “present”)” and an English term “present” are described as a second object. Consequently, the natural language sentence written in Japanese and the natural language sentence written in English can be associated with each other via an interlingua representation common to them. The word information here indicates an attribute value corresponding to an attribute “PRED” in an f-structure, and indicates a node in a case structure representation.

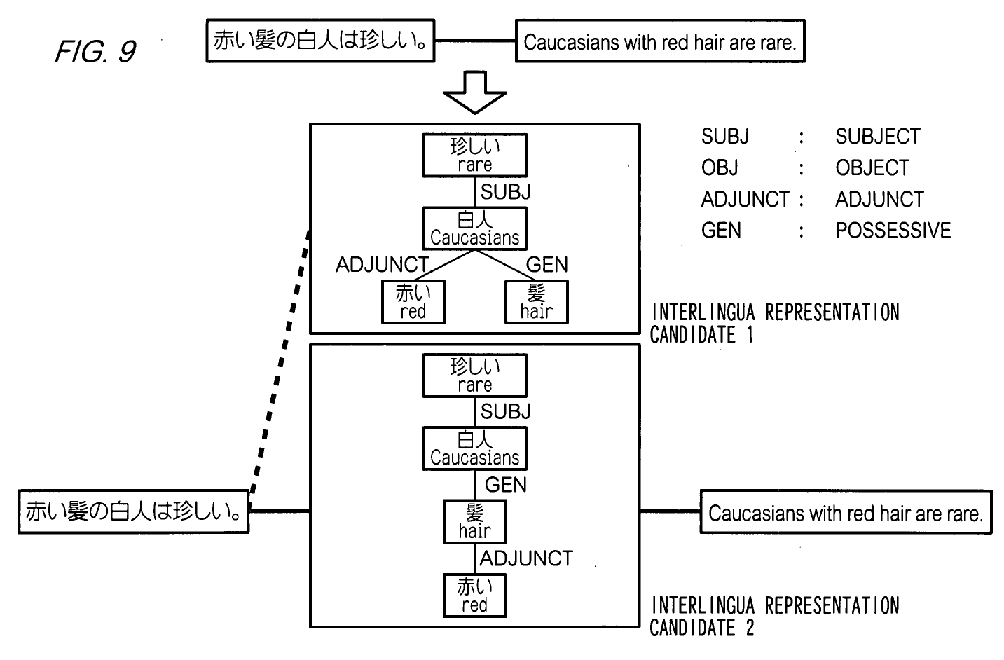

The above example described with reference to FIG. 8 is a case where natural language sentences to be translated into interlingua representations have no ambiguity. However, in a case where a natural language sentence to be translated into an interlingua representation has ambiguity, the natural language sentence can be translated into plural interlingua representations as shown in FIG. 9. Such a case often occurs especially when a natural language sentence written in Japanese is translated into an interlingua representation. In an example shown in FIG. 9, a Japanese sentence [symbol] [symbol] (a Japanese sentence meaning that Caucasians with red hair are rare)” is translated as a result of a syntactic and semantic analysis into an interlingua representation candidate 1 in which a term [symbol] (a Japanese term meaning “red”)” is interpreted to be dependent on a term [symbol] (a Japanese term meaning “Caucasians”)” and into an interlingua representation candidate 2 in which the term [symbol] (a Japanese term meaning “red”)” is interpreted to be dependent on a term [symbol] (a Japanese term meaning “hair”)”, and which of the interpretations is correct cannot be determined according to only the Japanese sentence. Consequently, the Japanese sentence is translated into two different interline representations as shown in FIG. 10.

However, according to the present embodiment, if a natural language sentence can be translated into plural interlingua representations as described above, an interlingua representation whose dependency relations are interpreted correctly is selected with reference to an interlingua representation of a different natural language sentence paired with the natural language sentence.

Specifically, pair creation unit 17 performs a syntactic and semantic analysis on, in addition to the Japanese sentence [symbol] (a Japanese sentence meaning that Caucasians with red hair are rare)”, an English sentence “Caucasians with red hair are rare.”, as shown in FIG. 9. As a result, if it is determined that the Japanese sentence can be translated into plural interlingua representations, an interlingua representation which corresponds to or is similar to an interlingua representation of the English sentence is selected as a correct interlingua representation from among the plural interlingua representations. This is because the English sentence has no ambiguity and therefore the interlingua representation thereof is considered to be correct, and because the interlingua representation of the English sentence paired with the Japanese sentence should correspond to or be similar to an interlingua representation of the Japanese sentence.

It is to be noted that estimation of similarity of interlingua representations may be made using a commonly used method such as that described in the publication cited above: Tetsuro Takahashi, Kentaro Inui, and Yuji Matsumoto, “Methods for Estimating Syntactic Similarity”, Information Processing Society of Japan Research Report, 2002-NL-150, pp. 163-170 (2002), in Japanese, contents of which are hereby incorporated by reference. As described in the publication, estimation of similarity of tree structures is made usually on the basis of two kinds of similarities: similarity of partial tree structures and similarity of nodes. In the present embodiment, as described above, words written in languages supported by translation memory system 101 are described as word information in a tree structure. Accordingly, when estimating similarity of a tree structure of an input sentence and a tree structure of a sentence paired with the input sentence, similarity of nodes can be estimated with a high degree of accuracy.

Also, since words written in languages supported by translation memory system 101 are described as word information in an interlingua representation (e.g. tree structure), difficulty in a translation of a word having semantic ambiguity is eliminated. For example, an English word “bank” can be translated as a Japanese word [symbol] (a Japanese word meaning a business that keeps and lends money)”, and as a Japanese word [symbol] (a Japanese word meaning a land along the side of a river)”, and it is difficult to determine which of the translations is appropriate. However, if the English word “bank” and a French word “banque” are described as word information in an interlingua representation, it can be determined that the Japanese word [symbol] (a Japanese word meaning a business that keeps and lends money)” is an appropriate translation, because the French word “banque” does not have the meaning of [symbol] (a Japanese word meaning a land along the side of a river)”.

As described above, according to the present embodiment, an interlingua representation can be created on the basis of a bilingual pair of natural language sentences written in different languages. When the interlingua representation is created, the natural language sentences are subject to a syntactic and semantic analysis, interlingua representation candidates of the sentences obtained on the basis of the analysis result are compared with each other, and an interlingua representation candidate common to the sentences is paired with each of the sentences. Accordingly, if a natural language sentence to be translated into an interlingua representation has ambiguity, a correct interlingua representation can be created. The degree of correctness of the interlingua representation is improved as the number of natural language sentences associated with each other grows. Also, even if a word of a source language sentence can be interpreted in plural ways, the word can be translated into an appropriate word by referring to words described as word information in an interlingua representation corresponding to the source language sentence.

It is to be noted that the above examples explained with reference to FIGS. 8 and 9 are cases where case structure representations of a bilingual pair correspond to each other completely, but it is possible that even a pair of interlingua representations which has highest level similarity do not correspond to each other completely. In such a case, an interlingua representation paired with a natural language sentence and an interlingua representation paired with the other natural language sentence may be different.

Also, in the above embodiment, in a case where a natural language sentence can be translated into plural different interlingua representations due to ambiguity of the sentence, a correct interlingua representation may be determined by identifying dependency relations of words constituting the sentence and types of the dependencies manually. A method for identifying dependency relations of words constituting a sentence and types of the dependencies manually is proposed in, for example, Japanese Patent Application Laid-open Publication No. 2003-242136, contents of which are hereby incorporated by reference.

### 3. Third Embodiment

The present embodiment is intended to provide a translation memory system which analyzes a “structure” of a source language sentence and enables translation of a part of the structure (hereinafter, referred to as a “partial structure”).

In a related art translation memory system, when a collection of bilingual pairs is searched for a natural language sentence which corresponds to or is similar to an input sentence, the similarity of the sentences is determined on the basis of only “surface information” of the sentences such as a notation and an order of words. Accordingly, if a long natural language sentence as described below is input into the translation memory system, it is highly unlikely that a target language sentence which corresponds to or is similar to the input sentence exists in a collection of bilingual pairs.

“The supreme court rendered a judgement that an abatement of a rent is allowed in a legal case where it is fought on the basis of whether an abatement of a rent is allowed because of a change of the economy when a “non-abatement of rent special contract” which allows an increase of a rent but does not allow a decrease of a rent is made along with a ground lease contract during a bubble period.”

The problem is increasingly likely to occur as an input natural language sentence is lengthened. If a corresponding or similar target language sentence does not exist in a collection of bilingual pairs, all words of the input natural language sentence have to be translated manually, which is inefficient.

To address the problem, translation memory system 102 according to the present embodiment analyzes a structure of an input natural language sentence, identifies an interlingua representation which corresponds to or is similar to a partial structure constituting the structure, and extracts a natural language sentence paired with the interlingua representation. Translation memory system 102 is the same as translation memory system 100 according to the first embodiment shown in FIG. 3 in its configuration, but not in its operation. Accordingly, a block diagram of translation memory system 102 is omitted.

Now, the most superordinate partial structure of a case structure representation of the above long sentence is simple, as shown in FIG. 11, and it is highly possible that such a simple case structure representation is stored in pair storage unit 11. In fact, when search unit 13 uses the most superordinate partial structure of the sentence as a unit for searching pair storage unit 11, a partial English sentence “The supreme court rendered a judgement . . . in a legal case . . . ” is highly likely to be used.

Search unit 13 searches pair storage unit 11 for an interlingua representation which corresponds to or is similar to an interlingua representation of the English sentence (a source language sentence) “The supreme court rendered a judgement . . . in a legal case . . . ”. Subsequently, search unit 13 extracts a Japanese sentence (a target language sentence) . . . [symbol] . . . [symbol] . . . [symbol] (a Japanese sentence meaning that the supreme court rendered a judgement . . . in a legal case . . . )” paired with the identified interlingua representation from pair storage unit 11, and the Japanese sentence is output by output unit 14. A translator who has received the translation result has to translate only English descriptions corresponding to the blank spaces of the Japanese sentence manually.

As described above, according to the present embodiment, even if an interlingua representation of a whole source language sentence has not been stored in advance, a structure of the sentence is analyzed and an interlingua representation of a partial structure of the sentence is identified, and thereby at least a part of the sentence can be translated.

Incidentally, in the present embodiment, other than the most superordinate partial structure of a case structure representation, any partial structure such as a relative clause or an embedded clause in a sentence may be used as a unit for searching pair storage unit 11.

### 4. Fourth Embodiment

The fourth embodiment is intended to provide a translation memory system with a machine translation function, and more specifically a translation memory system which enables an accurate machine translation into even a language which is not supported by the translation memory system as a target language.

FIG. 12 is a block diagram illustrating a configuration of translation memory system 103 according to the present embodiment. As shown in the drawing, in translation memory system 103, in addition to pair storage 11, syntactic and semantic analysis unit 12, output unit 14, word dictionary 15, bilingual pair storage unit 16, and pair creation unit 17 which are realized in translation memory system 101 according to the second embodiment, machine translation unit 21 is realized instead of search unit 13. Machine translation unit 21 is a translation engine which creates a target language sentence on the basis of an input interlingua representation.

Below, an operation of translation memory system 103 will be described by taking a case of translating Swedish into Portuguese as an example. In the example, it is assumed that pair storage unit 11 of translation memory system 103 stores pairs of an interlingua representation and each of Swedish, English, French, German, Spanish, and Italian sentences, as shown in FIG. 5. Also, it is assumed that word dictionary 15 of translation memory system 103 is for translation between Portuguese and each of English, Swedish, French, German, Spanish, and Italian.

Since translation memory system 103 does not support Portuguese as a target language, in the present embodiment, machine translation unit 21 performs a machine translation into Portuguese with reference to word dictionary 15. The problem here is a translation of a word having semantic ambiguity, such as the above-mentioned English word “bank” which can be translated in plural ways. It is difficult to determine an appropriate word in a case where there are plural Portuguese words corresponding to a Swedish word.

To address the problem, in the present embodiment, words written in plural different languages are described in an interlingua representation as word information, as shown in FIGS. 8, 9, and 11. In the examples shown in FIGS. 8, 9, and 11, words written in two languages: English and Japanese are described as word information. However, in this example, since pairs of an interlingua representation and each of Swedish, English, French, German, Spanish, and Italian sentences are stored in pair storage unit 11, words written in six languages are described as word information.

When a Swedish sentence is input into a thus configured translation memory system 103, machine translation unit 21 of translation memory system 103 searches pair storage unit 11 to identify an interlingua representation corresponding to the Swedish sentence. On identifying a corresponding interlingua representation, machine translation unit 21 translates words written in the six languages into Portuguese with reference to word dictionary 15. Machine translation unit 21 selects an overlapping Portuguese word from among the Portuguese words obtained as a result of the translation, and constitutes a Portuguese sentence with the selected word.

As described above, according to the present embodiment, an interlingua representation is paired with natural language sentences written in plural languages, and words written in the languages are described as word information in the interlingua representation. Consequently, even if an input source language sentence is translated into a language which is not supported by a translation memory system as a target language, appropriate words can be selected when a natural language sentence written in the target language is created.

Incidentally, programs for realizing the translation memory systems described in the above embodiments may be stored in a computer-readable recording medium such as a magnetic recording medium, an optical recording medium, and a ROM, and provided to an existing translation memory system via the recording medium. Also, the programs may be downloaded into an existing translation memory system via a network such as the Internet.

As described above, the present invention provides a translation memory system including: a memory which stores plural pairs of a natural language sentence written in a first language and an interlingua representation of the natural language sentence; an analysis unit which performs a syntactic and semantic analysis on a natural language sentence written in a second language and translates the natural language sentence into an interlingua representation on the basis of the analysis result; a search unit which searches the memory to identify an interlingua representation which corresponds to or has a predetermined level of similarity to the interlingua representation obtained by the analysis unit, and which extracts a natural language sentence written in the first language paired with the identified interlingua representation; and an output unit which outputs the natural language sentence extracted by the search unit as a translation result.

According to the translation memory system, if a natural language sentence written in a source language which is not supported by the system is input, an analysis unit performs a syntactic and semantic analysis on the natural language sentence and translates the natural language sentence into an interlingua representation on the basis of the analysis result; a search unit identifies an interlingua representation which corresponds to or has a predetermined level of similarity to the interlingua representation, and extracts a natural language sentence written in a target language paired with the identified interlingua representation; and an output unit outputs the extracted natural language sentence as a translation result.

The memory may store a case structure representation as the interlingua representation; and the syntactic and the analysis unit may translate the natural language sentence written in the second language into a case structure representation on the basis of the analysis result. Also, the interlingua representation stored in the memory may have a tree structure; and the analysis unit may perform a syntactic and semantic analysis based on Lexical Functional Grammar on the natural language sentence written in the second language, and translate the natural language sentence into an interlingua representation having a tree structure on the basis of the analysis result. Also, the interlingua representation stored in the memory may have a tree structure; and the analysis unit may perform a syntactic and semantic analysis based on Head-driven Phrase Structure Grammar on the natural language sentence written in the second language, and translate the natural language sentence into an interlingua representation having a tree structure on the basis of the analysis result.

According to an embodiment of the present invention, the memory may further store plural pairs of a natural language sentence written in another language and an interlingua representation of the other language. In this case, the translation memory system can translate an input natural language sentence into plural languages.

According to another embodiment of the present invention, the search unit, if the natural language sentence written in the second language is a sentence which can be translated into several different interlingua representations as a result of the syntactic and semantic analysis, may identify an interlingua representation from among the interlingua representations which is similar to an interlingua representation stored in the memory, and extract a natural language sentence written in the first language paired with the identified interlingua representation. In this case, if an input natural language sentence can be translated into plural interlingua representations due to ambiguity of dependency relations of words constituting the sentence, a natural language sentence written in a target language whose dependency relations are interpreted correctly can be selected.

According to another embodiment of the present invention, words written in plural languages may be described as word information in the interlingua representation stored in the memory. Consequently, even if a word of a source language sentence can be interpreted in plural ways, the word can be translated into an appropriate word by referring to words described as word information in an interlingua representation corresponding to the source language sentence.

According to another embodiment of the present invention, the translation memory system may further include a pair creation unit which performs a syntactic and semantic analysis on a bilingual pair of first and second natural language sentences written in two different languages, compares interlingua representations into which the first natural language sentence can be translated as a result of the syntactic and semantic analysis and interlingua representations into which the second natural language can be translated as a result of the syntactic and semantic analysis to identify interlingua representations of the first and second natural language sentence which are similar to each other, pairs the first natural language sentence with the identified interlingua representation of the first natural language sentence, and pairs the second natural language sentence with the identified interlingua representation of the second natural language sentence, and the memory may store the pairs created by the pair creation unit. In this case, a correct interlingua representation can be created on the basis of a bilingual pair of natural language sentences.

According to another embodiment of the present invention, the search unit may identify an interlingua representation which corresponds to or has a predetermined level of similarity to a partial structure of the interlingua representation obtained by the analysis unit. In this case, even if an interlingua representation of a whole source language sentence has not been stored in advance, a structure of the sentence is analyzed and an interlingua representation of a partial structure of the sentence is identified, and thereby at least a part of the sentence can be translated.

According to another embodiment of the present invention, the translation memory system may further include a machine translation unit which creates a natural language sentence written in a third language on the basis of an interlingua representation stored in the memory; and a word dictionary which is used for translation between the third language and each of plural languages of words described in the interlingua representation as word information, and the machine translation unit, when selecting a word during the creation of the natural language sentence written in the third language, may translate the words described in the interlingua representation as word information into words written in the third language with reference to the word dictionary, and select a word having a common translation between the translated words. In this case, an interlingua representation is paired with natural language sentences written in plural languages, and words written in the languages are described as word information in the interlingua representation. Consequently, even if an input source language sentence is translated into a language which is not supported by a translation memory system as a target language, appropriate words can be selected when a natural language sentence written in the target language is created.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, to thereby enable others skilled in the art to understand various embodiments of the invention and various modifications thereof, to suit a particular contemplated use. It is intended that the scope of the invention be defined by the following claims and their equivalents.

What is claimed is:

1. A translation memory system comprising:
a memory which stores a plurality of pairs of a natural language sentence written in a first language and an interlingua representation of the natural language sentence;
an analysis unit which performs a syntactic and semantic analysis on a natural language sentence written in a second language and translates the natural language sentence into an interlingua representation on the basis of the analysis result;
a search unit which searches the memory to identify an interlingua representation which corresponds to or has a predetermined level of similarity to the interlingua representation obtained by the analysis unit, and which extracts a natural language sentence written in the first language paired with the identified interlingua representation; and
an output unit which outputs the natural language sentence extracted by the search unit as a translation result.

2. A translation memory system according to claim 1, wherein:
the memory stores a case structure representation as the interlingua representation; and
the analysis unit translates the natural language sentence written in the second language into a case structure representation on the basis of the analysis result.

3. A translation memory system according to claim 1, wherein:
the interlingua representation stored in the memory has a tree structure; and
the analysis unit performs a syntactic and semantic analysis based on Lexical Functional Grammar on the natural language sentence written in the second language, and translates the natural language sentence into an interlingua representation having a tree structure on the basis of the analysis result.

4. A translation memory system according to claim 1, wherein:
the interlingua representation stored in the memory has a tree structure; and
the analysis unit performs a syntactic and semantic analysis based on Head-driven Phrase Structure Grammar on the natural language sentence written in the second language, and translates the natural language sentence into an interlingua representation having a tree structure on the basis of the analysis result.

5. A translation memory system according to claim 1, wherein the memory further stores a plurality of pairs of a natural language sentence written in another language and an interlingua representation of the other language.

6. A translation memory system according to claim 1, wherein the search unit, if the natural language sentence written in the second language is a sentence which can be translated into several different interlingua representations as a result of the syntactic and semantic analysis, identifies an interlingua representation from among the interlingua representations which is similar to an interlingua representation stored in the memory, and extracts a natural language sentence written in the first language paired with the identified interlingua representation.

7. A translation memory system according to claim 1, wherein words written in a plurality of languages are described as word information in the interlingua representation stored in the memory.

8. A translation memory system according to claim 1, further comprising a pair creation unit which performs a syntactic and semantic analysis on a bilingual pair of first and second natural language sentences written in two different languages, compares interlingua representations into which the first natural language sentence can be translated as a result of the syntactic and semantic analysis and interlingua representations into which the second natural language can be translated as a result of the syntactic and semantic analysis to identify interlingua representations of the first and second natural language sentence which are similar to each other, pairs the first natural language sentence with the identified interlingua representation of the first natural language sentence, and pairs the second natural language sentence with the identified interlingua representation of the second natural language sentence, wherein
the memory stores the pairs created by the pair creation unit.

9. A translation memory system according to claim 1, wherein the search unit identifies an interlingua representation which corresponds to or has a predetermined level of similarity to a partial structure of the interlingua representation obtained by the analysis unit.

10. A translation memory system according to claim 7, further comprising:
a machine translation unit which creates a natural language sentence written in a third language on the basis of an interlingua representation stored in the memory; and
a word dictionary which is used for translation between the third language and each of a plurality of languages of words described in the interlingua representation as word information, wherein the machine translation unit, when selecting a word during the creation of the natural language sentence written in the third language, translates the words described in the interlingua representation as word information into words written in the third language with reference to the word dictionary, and selects a word having a common translation between the translated words.
